(19) United States
(12) Patent Application Publication
(10) Pub. No.: US 2005/0266312 A1
(43) Pub. Date: Dec. 1, 2005

(54) Non-aqueous electrolyte secondary battery

(76) Inventors: Toyoki Fujihara, Naruto (JP); Hideki Kitao, Kobe-city (JP); Kazuhisa Takeda, Itano-gun (JP); Takaaki Ikemachi, Kobe-city (JP); Toshiyuki Nohma, Kobe-city (JP)

Correspondence Address: KUBOVCIK & KUBOVCIK, SUITE 710, 900 17TH STREET NW, WASHINGTON, DC, 20006, US

(21) Appl. No.: 11/135,351

(22) Filed: May 24, 2005

(30) Foreign Application Priority Data
May 25, 2004 (JP) 2004-154788

(51) Int. Cl. H01M 4/48; H01M 4/58; H01M 4/52; H01M 4/50

(52) U.S. Cl. 429/231.1; 429/231.95; 429/224; 429/231.3; 429/223

(57) ABSTRACT

Elevated-temperature durability (i.e., high-temperature storage performance) is improved in a non-aqueous electrolyte secondary battery that uses a layered lithium-transition metal composite oxide as a positive electrode active material. A non-aqueous electrolyte secondary battery includes: a positive electrode containing a layered lithium-transition metal composite oxide as a positive electrode active material, a negative electrode containing a negative electrode active material capable of intercalating and deintercalating lithium, and a non-aqueous electrolyte having lithium ion conductivity. The lithium-transition metal composite oxide contains boron and at least one element selected from the group IVa elements of the periodic table.

### BACKGROUND OF THE INVENTION

1. Field of the Invention

The present invention relates to non-aqueous electrolyte secondary batteries such as lithium secondary batteries.

2. Description of Related Art

A high energy density battery can be built with a non-aqueous electrolyte secondary battery that uses as a positive electrode active material a layered lithium-transition metal composite oxide, such as a lithium cobalt oxide and a lithium nickel oxide, because such a battery attains a large capacity and a high voltage, i.e., about 4 V. A problem, however, with using such positive electrode active materials is that battery capacity degrades if the battery is set aside in a charged state under a high temperature environment.

To solve this problem, such a technique has been proposed that the transition metal site in the lithium-transition metal composite oxide is substituted by a different kind of element or that the oxygen site is substituted by fluorine. For example, Japanese Patent No. 2855877 proposes a technique for suppressing oxidation decomposition of electrolyte solution on the surface of LiCoO₂ and stabilizing the crystal structure by adding zirconium to LiCoO₂.

However, it has been found that the addition of zirconium only as described above does not yield sufficient improvements in high-temperature storage performance.

### BRIEF SUMMARY OF THE INVENTION

Accordingly, it is an object of the present invention to provide a non-aqueous electrolyte secondary battery with improved elevated-temperature durability, that is, improved high-temperature storage performance in the field of non-aqueous electrolyte secondary batteries that use a layered lithium-transition metal composite oxide as a positive electrode active material.

In order to accomplish the foregoing and other objects, the present invention provides a non-aqueous electrolyte secondary battery comprising a positive electrode containing a layered lithium-transition metal composite oxide as a positive electrode active material, a negative electrode containing a negative electrode active material capable of intercalating and deintercalating lithium, and a non-aqueous electrolyte having lithium ion conductivity, wherein the lithium-transition metal composite oxide contains boron and at least one element selected from the group IVa elements of the periodic table.

### DETAILED DESCRIPTION OF THE INVENTION

Adding, according to the present invention, boron and at least one element selected from the group IVa elements of the periodic table to the lithium-transition metal composite oxide used as the positive electrode active material makes it possible to build a non-aqueous electrolyte secondary battery that exhibits good elevated-temperature durability (high-temperature storage performance).

Preferable group IVa elements of the periodic table are Ti, Zr, and Hf. More preferable is Ti or Zr, or a combination thereof, and especially preferable is Zr. Accordingly, it is preferable that the at least one element selected from group IVa elements of the periodic table be Zr, or a combination of Zr and another group IVa element.

The total amount of boron and the group IVa element(s) of the periodic table added is preferably 10 mole % or less with respect to the total amount of these elements and the transition metal element, more preferably within the range of from 0.1 to 5.0 mole %, and still more preferably within the range of from 0.25 to 2.0 mole %. If the amount of boron and the group IVa element(s) of the periodic table added is too small, the improvement in the elevated-temperature durability may not be sufficient. On the other hand, if the amount of these substances added is too large, the rate characteristics of the battery may degrade although the elevated-temperature durability improves.

In the present invention, the proportion of boron to the group IVa element(s) of the periodic table is preferably within the range of from 1/5 to 5/1 based on mole ratio (boron/group IVa element(s)), and more preferably within the range of from 1/3 to 3/1. By restricting the proportion of boron to the group IVa element(s) of the periodic table within these ranges, elevated-temperature durability can be further improved.

It is preferable that the lithium-transition metal composite oxide used in the present invention contain Ni for the purpose of increasing battery capacity, and it is more preferable that it further contain Mn for the purpose of enhancing structural stability. In other words, it is preferable that the lithium-transition metal composite oxide contain at least Ni and Mn as transition metals. For the purpose of further enhancing structural stability, it is more preferable that the lithium-transition metal composite oxide further contain Co.

The lithium-transition metal composite oxide used as a positive electrode active material in the present invention may be represented by, for example, the formula LiₐMₓM′_{y}B_{z}O₂, where: M is at least one element selected from the group consisting of Mn, Co, and Ni; M′ is at least one element selected from the group IVa elements of the periodic table; and a, x, y, and z satisfy the equations 0.95≦a<1.2, a+x+y+z=2, 0.7≦x<1.05, 0<y≦0.05, and 0<z≦0.05.

In the present invention, it is preferable that a lithium-manganese composite oxide having a spinel structure be mixed with the lithium-transition metal composite oxide to be used as the positive electrode active material. It is preferable that the weight ratio of the lithium-transition metal composite oxide to the lithium-manganese composite oxide having a spinel structure (lithium-transition metal composite oxide:lithium-manganese composite oxide), when used as a mixture, be within the range of 1:9 to 9:1, and more preferably within the range of 6:4 to 9:1. By adopting the mixture at such ranges, elevated-temperature durability can be improved further.

According to the present invention, the use of a lithium-transition metal composite oxide to which boron and a group IVa element of the periodic table are added can improve elevated-temperature durability (high-temperature storage performance). The details of the mechanism of its working are not yet clear. However, it is known that boron and a group IVa element form a strong metallic substance, such as ZrB₂ or TiB₂, so it is believed that they serve to stabilize the surface or bulk of the lithium-transition metal composite oxide. Thus, it is thought that the addition of boron and a group IVa element to a lithium-transition metal composite oxide is more effective than the addition of a group IVa element of the periodic table alone, in that it more effectively brings about such effects as suppressing side reactions of the lithium-transition metal composite oxide with an electrolyte solution or a decomposed product of the electrolyte solution and thereby preventing deterioration of the active material surface due to the side reactions. Furthermore, it is believed that by preventing the transition metals in the lithium-transition metal composite oxide from dissolving out, elevated-temperature durability is enhanced. According to the present invention, by adding boron and a group IVa element of the periodic table to the lithium-transition metal composite oxide, elevated-temperature durability can be enhanced to a greater degree than in the case in which a group IVa element alone is added.

In the present invention, an example of the method of adding boron and a group IVa element of the periodic table to the lithium-transition metal composite oxide includes a method in which a compound of boron (oxide, hydroxide, carbonate, or the like) and a compound of a group IVa element (oxide, hydroxide, carbonate, or the like) are mixed with other source materials that form a lithium-transition metal composite oxide at a predetermined ratio, and then the mixture is baked, whereby a lithium-transition metal composite oxide containing boron and a group IVa element is obtained.

It is known that the group Va elements of the periodic table, as well as the group IVa elements, form strong metallic substances with boron (for example, VB₂, NbB₂, TaB₂, etc.). Accordingly, adding boron and a group Va element of the periodic table to a lithium-transition metal composite oxide also makes it possible to obtain a positive electrode active material with good elevated-temperature durability, as in the present invention. Preferable examples of the group Va elements of the periodic table include V, Nb, and Ta, and particularly preferable is V, Nb, or a combination thereof.

In the present invention, although the negative electrode active material used for the negative electrode is not particularly limited as long as it is usable for non-aqueous electrolyte secondary batteries, carbon materials are preferably used. Among the carbon materials, graphite materials are particularly preferable.

For the non-aqueous electrolyte, any electrolyte that is used for non-aqueous electrolyte secondary batteries may be used without limitation. The solvent of the electrolyte is not particularly limited, and usable examples include: cyclic carbonates, such as ethylene carbonate, propylene carbonate, butylene carbonate, and vinylene carbonate; and chain carbonates, such as dimethyl carbonate, methyl ethyl carbonate, and diethyl carbonate. Particularly preferable is a mixed solvent of a cyclic carbonate and a chain carbonate. An additional example is a mixed solvent of one of the above-described cyclic carbonates and an ether-based solvent such as 1,2-dimethoxyethane or 1,2-diethoxyethane.

The solute of the electrolyte is not particularly limited; examples thereof include LiPF₆, LiBF₄, LiCF₃SO₃, LiN(CF₃SO₂)₂, LiN(C₂F₅SO₂)₂, LiN(CF₃SO₂) (C₄F₉SO₂), LiC(CF₃SO₂)₃, LiC(C₂F₅SO₂)₃, LiAsF₆, LiClO₄, Li₂B₁₀Cl₁₀, Li₂B₁₂Cl₂, and mixtures thereof.

By using, according to the present invention, a lithium-transition metal composite oxide to which boron and at least one element among the group IVa elements of the periodic table are added as a positive electrode active material, elevated-temperature durability, that is, high-temperature storage performance of the battery can be enhanced.

### DESCRIPTION OF THE PREFERRED EMBODIMENTS

Hereinbelow, the present invention is described in further detail. It should be understood, however, that the present invention is not limited to the following preferred embodiments but various changes and modifications are possible within the scope of the invention as defined in the appended claims.

### EXAMPLE 1

Preparation of Lithium-transition Metal Composite Oxide Li₂CO₃, (Ni_{0.4}CO_{0.3}Mn_{0.3})₃O₄, ZrO₂, and B₂O₃ were mixed at a mole ratio of Li: (Ni_{0.4}CO_{0.3}Mn_{0.3}): Zr: B=1.00:0.99:0.005:0.005, and the mixture was baked at 900° C. for 20 hours in an air atmosphere, so that LiNi_{0.396}Co_{0.297}Mn_{0.297}Zr_{0.005}B_{0.005}O₂ was obtained.

Preparation of Positive Electrode

The lithium-transition metal composite oxide prepared in the above-described manner and a lithium-manganese composite oxide (Li_{1.1}Mn_{1.9}O₄) having a spinel structure were mixed at a weight ratio (lithium-transition metal composite oxide:lithium-manganese composite oxide) of 7:3, and the resultant mixture was used as a positive electrode active material. This mixture (positive electrode active material), a carbon material as a conductive agent, and a N-methyl-2-pyrrolidone solution in which polyvinylidene fluoride was dissolved, as a binder agent, were mixed so that the weight ratio of the active material, the conductive agent, and the binder agent resulted in 90:5:5 to prepare a positive electrode slurry. The prepared slurry was applied onto an aluminum foil as a current collector, and then dried. Thereafter, the resultant current collector was pressure-rolled using pressure rollers, and a current collector tab was attached thereto. A positive electrode was thus prepared.

Preparation of Negative Electrode

Graphite as a negative electrode active material, SBR as a binder agent, and an aqueous solution in which carboxymethylcellulose was dissolved as a thickening agent were kneaded so that the weight ratio of the active material, the binder agent, and the thickening agent became 98:1:1, and thus, a negative electrode slurry was prepared. The prepared slurry was applied onto a copper foil as a current collector, and then dried. Thereafter, the resultant current collector was pressure-rolled using pressure rollers, and a current collector tab was attached thereto. A negative electrode was thus prepared.

Preparation of Electrolyte Solution

LiPF₆ as a solute was dissolved at 1 mole/liter in a solvent in which ethylene carbonate (EC) and diethyl carbonate (DEC) were mixed at a volume ratio of 3:7. An electrolyte solution was thus prepared.

Assembling of Non-Aqueous Electrolyte Secondary Battery

The positive electrode and the negative electrode prepared in the above-described manner were coiled around with a polyethylene separator interposed therebetween to prepare a wound assembly. In a glove box under an argon atmosphere, the resultant wound assembly was enclosed into a battery can together with the electrolyte solution. Thus, a cylindrical type of 18650 size (with 18 mm diameter and 65 mm height) non-aqueous electrolyte secondary battery A having a rated capacity of 1.4 Ah was fabricated.

### COMPARATIVE EXAMPLE 1

As in the preparation of the lithium-transition metal composite oxide of Example 1, Li₂CO₃, (Ni_{0.4}CO_{0.3}Mn_{0.3})₃O₄, and ZrO₂ were mixed so that the mole ratio thereof became Li: (Ni_{0.4}CO_{0.3}Mn_{0.3}) Zr=1.00:0.995:0.005, and the mixture was baked at 900° C. for 20 hours in an air atmosphere so that LiNi_{0.398}CO_{0.298}Mn_{0.299}Zr_{0.005}O₂ was obtained. Except that the resultant lithium-transition metal composite oxide was mixed with a lithium-manganese composite oxide as in Example 1 and the resultant mixture was used as the positive electrode active material, a cylindrical 18650 size non-aqueous electrolyte secondary battery X having a rated capacity of 1.4 Ah was fabricated in the same manner as in Example 1.

### COMPARATIVE EXAMPLE 2

As in the preparation of the lithium-transition metal composite oxide of Example 1, Li₂CO₃, (Ni_{0.4}CO_{0.3}Mn_{0.3})₃O₄, and ZrO₂ were mixed so that the mole ratio thereof became Li: (Ni_{0.4}CO_{0.3}Mn_{0.3}): Zr=1.00:0.99:0.01, and the mixture was baked at 900° C. for 20 hours in an air atmosphere so that LiNi_{0.396}CO_{0.297}Mn_{0.297}Zr_{0.01}O₂ was obtained. Except that the resultant lithium-transition metal composite oxide was mixed with a lithium-manganese composite oxide as in Example 1 and the resultant mixture was used as the positive electrode active material, a cylindrical 18650 size non-aqueous electrolyte secondary battery Y having a rated capacity of 1.4 Ah was fabricated in the same manner as in Example 1.

### COMPARATIVE EXAMPLE 3

As in the preparation of the lithium-transition metal composite oxide of Example 1, Li₂CO₃, and (Ni_{0.4}CO_{0.3}Mn_{0.3})₃O₄ were mixed so that the mole ratio thereof became Li: (Ni_{0.4}CO_{0.3}Mn_{0.3})=1.00:1.00, and the mixture was baked at 900° C. for 20 hours in an air atmosphere so that LiNi_{0.4}CO_{0.3}Mn_{0.3}O₂ was obtained. Except that the resultant lithium-transition metal composite oxide was mixed with a lithium-manganese composite oxide as in Example 1 and the resultant mixture was used as the positive electrode active material, a cylindrical 18650 size non-aqueous electrolyte secondary battery Z having a rated capacity of 1.4 Ah was fabricated in the same manner as in Example 1.

Measurement of Battery's Rated Capacity

Rated capacities of the batteries A, X, Y, and Z were measured. To obtain the rated capacity of the batteries, the batteries were charged at a 1400 mA constant current-constant voltage (cut-off at 70 mA) to 4.2 V, and then, with setting the end-of-discharge voltage at 3.0 V, discharged at 470 mA to 3.0 V, wherein the battery capacity was obtained and taken as the rated capacities.

Measurement of Battery's I-V Resistance

Measurements were performed to obtain I-V resistances of the batteries A, X, Y, and Z. Each battery was charged at 1400 mA to 50% SOC. Thereafter, around 50% SOC, charging and discharging of each battery were carried out for 10 seconds at 280 mA, 700 mA, 2100 mA, and 4200 mA. The battery voltages after 10 seconds in the respective cases were plotted against the respective current values, and the gradient was taken as the I-V resistance.

Storage Performance Test

The batteries A, X, Y, and Z were charged at 1400 mA to 50% SOC, and thereafter subjected to a 30-day storage test at a constant temperature in which the temperature was kept at 65° C. After the storage, their rated capacities were measured in the same manner as described above to obtain their capacity recovery ratios. The capacity recovery ratios was calculated by dividing the battery rated capacities after the storage test by the battery rated capacities before the storage test. Further, after measuring the rated capacities, an I-V resistance measurement was conducted in the same manner as described above. From the results, increases in I-V resistance before and after the storage test were calculated. The capacity recovery ratios and the increases in I-V resistance before and after the storage are shown in Table 1.

TABLE 1

| | | | | Increase in I-V | |
|---|---|---|---|---|---|
| | | | Capacity | resistance before | |
| | | | recovery | and after storage | |
| | | Element | ratio | (mΩ) | |
| | Battery | added | (%) | Charge | Discharge |
| Ex. 1 | A | Zr: 0.5 | 90.3 | 4.0 | 6.6 |
| | | mole % | | | |
| | | B: 0.5 | | | |
| | | mole % | | | |
| Comp. Ex. 1 | X | Zr: 0.5 | 86.7 | 5.5 | 6.8 |
| | | mole % | | | |
| Comp. Ex. 2 | Y | Zr: 1.0 | 88.1 | 6.2 | 8.0 |
| | | mole % | | | |
| Comp. Ex. 3 | Z | — | 87.8 | 5.6 | 8.4 |

The results shown in Table 1 clearly demonstrate that, by using, according to the present invention, the lithium-transition metal composite oxide containing boron and a group IVa element as its positive electrode active material, elevated-temperature durability (i.e., high-temperature storage performance) of the battery can be improved over the case in which a group IVa element alone is added.

It should be noted that although Li₂CO₃, (Ni_{0.4}CO_{0.3}Mn_{0.3})₃O₄, ZrO₂, and B₂O₃ were used in the present example as starting materials for making a lithium-transition metal composite oxide, these materials are not intended to limit the present invention. For example, the source material for Li may be LiOH, Li₂O, or the like, and the source material for NiCoMn may be Ni_{0.4}CO_{0.3}Mn_{0.3}(OH)₂ or the like. Also, the source material for Zr may be Zr(OH)₄ or the like, and the source material for B may be H₃BO₃ or the like.

Only selected embodiments have been chosen to illustrate the present invention. To those skilled in the art, however, it will be apparent from the foregoing disclosure that various changes and modifications can be made herein without departing from the scope of the invention as defined in the appended claims. Furthermore, the foregoing description of the embodiments according to the present invention is provided for illustration only, and not for limiting the invention as defined by the appended claims and their equivalents.

This application claims priority of Japanese Patent Application No. 2004-154788, which is incorporated herein in its entirety by reference.

1. A non-aqueous electrolyte secondary battery, comprising a positive electrode containing a layered lithium-transition metal composite oxide as a positive electrode active material, a negative electrode containing a negative electrode active material capable of intercalating and deintercalating lithium, and a non-aqueous electrolyte having lithium ion conductivity, wherein
said lithium-transition metal composite oxide contains boron and at least one element selected from the group IVa elements of the periodic table.

2. The non-aqueous electrolyte secondary battery according to claim 1, wherein said lithium-transition metal composite oxide is represented by the formula LiₐMₓM′_{y}B_{z}O₂, where: M is at least one element selected from the group consisting of Mn, Co, and Ni; M′ is at least one element selected from the group IVa elements of the periodic table; and a, x, y, and z satisfy the equations 0.95≦a<1.2, a+x+y+z=2, 0.7≦x<1.05, 0<y≦0.05, and 0<z≦0.05.

3. The non-aqueous electrolyte secondary battery according to claim 1, wherein said at least one element selected from the group IVa elements is Zr, or a combination of Zr and another group IVa element.

4. The non-aqueous electrolyte secondary battery according to claim 2, wherein said at least one element selected from the group IVa elements is Zr, or a combination of Zr and another group IVa element.

5. The non-aqueous electrolyte secondary battery according to claim 1, wherein said lithium-transition metal composite oxide contains at least Ni and Mn as transition metals.

6. The non-aqueous electrolyte secondary battery according to claim 5, wherein said lithium-transition metal composite oxide further contains Co as a transition metal.

7. The non-aqueous electrolyte secondary battery according to claim 1, wherein said positive electrode active material comprises a mixture of said lithium-transition metal composite oxide and a lithium-manganese composite oxide having a spinel structure.

8. The non-aqueous electrolyte secondary battery according to claim 5, wherein said lithium-transition metal composite oxide is represented by the formula LiₐMₓM′_{y}B_{z}O₂, where: M is at least one element selected from the group consisting of Mn, Co, and Ni; M′ is at least one element selected from the group IVa elements of the periodic table; and a, x, y, and z satisfy the equations 0.95≦a<1.2, a+x+y+z=2, 0.7≦x<1.05, 0<y≦0.05, and 0<z≦0.05.

9. The non-aqueous electrolyte secondary battery according to claim 8, wherein said at least one element selected from the group IVa elements is Zr, or a combination of Zr and another group IVa element.

10. The non-aqueous electrolyte secondary battery according to claim 5, wherein said positive electrode active material comprises a mixture of said lithium-transition metal composite oxide and a lithium-manganese composite oxide having a spinel structure.
